(19) United States
(12) Patent Application Publication
(10) Pub. No.: US 2008/0126465 A1
(43) Pub. Date: May 29, 2008

(54) Calendar-based Financial Calculator

(76) Inventor: Iain Michael Delaney, Oakville (CA)

Correspondence Address: GOWAN INTELLECTUAL PROPERTY, 1075 NORTH SERVICE ROAD WEST, SUITE 203, OAKVILLE, ON, L6M-2G2, omitted

(21) Appl. No.: 11/460,962

(22) Filed: Jul. 28, 2006

(51) Int. Cl. G06F 7/38; G06F 3/048

(52) U.S. Cl. 708/490; 715/764

(57) ABSTRACT

A computer operated, calendar-based financial calculator comprises a computer display, calendar calculating software, and a calculation engine, so as to provide a visual presentation of any calendar month. Each day of each month of each year has a unique numerical value which can be understood and acted upon by the calculation engine. A value cell can be presented in a date cell being displayed on the computer display, and a numerical value or a mathematical expression may be entered into the value cell. The calculation engine is adapted to calculate a value for a similar identified value cell in any other date cell in keeping with the numerical value entered into an operating identified value cell presently being displayed, and in keeping with a predetermined governing mathematical expression which has been previously entered for that operating identified value cell.

### FIELD OF THE INVENTION

This invention relates to computer programs, and more particularly to a computer program which offers a calendar-based financial calculator, whereby deposits and withdrawals, checks, and other transactions may be tracked in a financial account in such a manner that the account balance, for example, will be automatically updated each time any transaction takes place. Thus, the present invention provides a computer program that has computer calendar presentation facilities coupled with spreadsheet functionality.

### BACKGROUND OF THE INVENTION

The present invention differs significantly from a computer calendar program, in that it provides a calculating tool which uses a grid that is preferably set up as a calendar, so that it has seven columns and as many as six rows of data, such that any month of a calendar year may be displayed on a computer display; it being recognized that there are seven days in each week, and that there may be at least one or two days in as many as six weeks in any calendar month having 30 or 31 days.

Moreover, the present invention differs significantly from a spreadsheet computer program because it is particularly adapted for time—based or temporal calculations. A spreadsheet will have formulas that can contain references to values in other grid cells so that the results can update themselves when the referenced values change; but the present invention will make calculations and update values in other value cells based not only on the mathematical calculation which must be made but also on the date, or day of week or day of month of the other value cell or cells to be updated.

What the present invention does provide is a computer program that permits the user to view and to compute time-based values, where the values are shown and represented in a calendar format. Thus, the calendar representation which is seen on a computer display will show values or the results of calculations in date cells shown on a calendar grid. Those values can be either numbers or mathematical equations or expressions which may be entered into value cells shown on the calendar grid by direct entry or as a consequence of computer calculations in keeping with mathematical expressions which have previously been entered.

This manner of presentation also differs from computer-based financial programs such as Quicken, because while the invention provides time-based or temporal calculations, it does not display financial entries, or maintain and display a running balance in an account as if it were in an ordinary bookkeeping ledger. Moreover, as mentioned, the present invention provides a program for display and calculations of values in a manner somewhat similar to spreadsheet functionality, but with time-based or temporal display characteristics.

While a running balance in an account will be maintained, it will be displayed in an appropriate manner in a specific value cell on any date cell. The present invention can accommodate repetitive weekly, monthly, or other regular payment schedules, deposits, or other transactions, without the necessity for continued entry of value data for each date when such a transaction will take place.

### DESCRIPTION OF THE PRIOR ART

A number of patents are known which provide calendar programs of one sort or another, including particularly those in which financial transactions or other information may be entered and displayed. However, none of those known Prior Art references includes the functionality of a spreadsheet; and none of those known Prior Art references provides a calendar grid having date cells with value cells embedded therein. The Prior Art comprises:

Huemoeller et al U.S. Pat. No. 5,855,006, issued Dec. 29, 1998, provides a personal activity signaling system which will access data from various sources so as to provide the user with information that is required to enable the user to schedule activities without requiring access to other sources of information. This is a calendar computer program, however, which has no spreadsheet functionality, and merely provides a system whereby other application data may be accessed. Moreover, no reliance is made upon access to data, and particularly so as to update financial data through entry or calculation in value cells displayed in date cells on a calendar display.

Grossman at al U.S. Pat. No. 4,910,696, issued Mar. 20, 1990, provides a computerized personal portable account register which is, to all intents and purposes, merely a calculator with various memory modes and keys which are typically dedicated so that particular command functions may be accessed, whereby budgeting and balancing data in a computerized checking account register will be maintained.

Strope et al U.S. Pat. No. 5,129,057, issued Jul. 7, 1992, and related U.S. Pat. No. 5,023,851, issued Jun. 11, 1991, provides a system wherein a calendar program is shown in side-by-side relationship with other programs, which may include a spreadsheet program. However, there is no attempt whatsoever to integrate one program within the other. The purpose is to provide the user the opportunity to interrupt the task that he is working on to determine the availability of a certain time period without leaving the current program.

Kapp et al U.S. Pat. No. 5,233,547, issued Aug. 3, 1993, also provides a checking account apparatus in which a digitizer is provided so as to receive information at the time that the check is written. However, when a calculation is made, the apparatus switches to a traditional spreadsheet display, and cancels the calendar display.

Winner U.S. Pat. No. 6,272,074, issued Aug. 7, 2001, provides a calendar program which can include repetitive events. However, those events are limited to schedule events and there is no consideration of mathematical calculations or other spreadsheet functionality.

Ishizaki et al U.S. Pat. No. 6,313,852, issued Nov. 6, 2001, provides a scheduling management system which has a software component that indicates a schedule whereby a member or a date may be moved to any one of a number of components displayed on a GUI screen. The software is set up so that the GUI screen will judge the type of the superposed software component, and thereby select a process to be performed.

### SUMMARY OF THE INVENTION

In accordance with one aspect of the present invention, there is provided a computer operated, calendar-based financial calculator which comprises a computer display, calendar calculating software, and a calculation engine.

Accordingly, in one aspect, the present invention provides a computer operated, calendar-based financial calculator comprising a computer display, calendar calculating software, and a calculation engine; wherein:
said calendar calculating software provides calendar data to said computer display so as to provide a visual presentation of any calendar month, preferably wherein said visual presentation comprises a calendar grid having seven columns and four to six rows of date cells, and wherein each day of each month of each year has a unique numerical value which can be understood and acted upon by said calculation engine;
wherein at least one identified value cell is present in each date cell being displayed on said computer display, and wherein a numerical value or a mathematical expression may be entered into said at least one identified value cell; and
wherein said calculation engine is adapted to calculate a value for a similar identified value cell in any other date cell in keeping with the numerical value entered into an operating identified value cell presently being displayed on said computer display, and in keeping with a predetermined governing mathematical expression which has been previously entered for that operating identified value cell.

The calendar calculating software provides calendar data to the computer display so as to provide a visual presentation of any calendar month The visual presentation comprises a calendar grid having seven columns and four to six rows of date cells. Each day of each month of each year has a unique numerical value which can be understood and acted upon by the calculation engine. As such, the date cell is a representation of the unique numerical value associated with each date.

At least one identified value cell is present in each date cell that is being displayed on the computer display. A numerical value or a mathematical expression may be entered into the at least one identified value cell. The value cell is a representation of the value associated with a selected category, account, or the like.

The calculation engine is adapted to calculate a value for a similar identified value cell in any other date cell in keeping with the numerical value entered into an operating identified value cell presently being displayed on the computer display, and in keeping with a predetermined governing mathematical expression which has been previously entered for that operating identified value cell.

The calculation engine maintains a list of all values and mathematical expressions for each value cell as a function of the unique date values for each date cell, so as to send updated values to any value cells for any selected date cells as determined by a respective predetermined governing mathematical expression therefor.

Typically, a plurality of value cells are present in each date cell being displayed on the computer display.

A value cell may be selected within a date cell, and a numerical value entered into a related value cell in the date cell will result in a calculation by the calculation engine for a numerical value to be displayed in a further related value cell in the date cell in keeping with the predetermined governing mathematical expression.

Moreover, the calculated numerical value may result in further calculated numerical values for the further related value cells in other date cells, as may be determined by the predetermined governing mathematical expression.

The computer display, the calendar calculating software, and the calculation engine, may be located in a single computer, or they may be distributed among a plurality of computers linked together by LAN, WAN, or Internet.

One feature of the invention is that data for differing financial categories, such as fuel expenses, food expenses, bank fees, pension income, or the like, or accounts, such as bank accounts, credit card accounts, pension accounts, or the like, may be displayed in any date cell by preselection of an account indicator, or by selection of a group of related value cells in a date cell.

The computer operated, calendar-based financial calculator is such that when a mathematical expression is entered into a value cell, it may cause a determination by the calculation engine of a numerical value entered into another value cell by reference to the identity of that other value cell.

Moreover, the numerical value which is displayed in any value cell may be entered as a raw number, or it may be a calculated value written into the value cell as a consequence of a calculation by the calculation engine in keeping with a predetermined governing mathematical expression for the value cell.

Also, the computer operated, calendar-based financial calculator of the present invention is such that any value cell may be created for a date cell, and repeated as to the numerical value or mathematical expression therein for further date cells.

When a mathematical expression is in a value cell and is repeated in further value cells for different date cells, the mathematical expression may be modified in keeping with the requisite unique value for the respective date cell or cells where the mathematical expression is to be repeated.

Finally, the computer operated, calendar-based financial calculator of the present invention is such that the calculation engine is capable of translating temporal relationships to unique date values, based on a unique reference date value, and to perform calculations in keeping with a predetermined governing mathematical expression based on the translated unique date values.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. In the drawings, like reference numerals depict like elements.

It is expressly understood, however, that the drawings are for the purpose of illustration and description only and are not intended as a definition of the limits of the invention. Embodiments of this invention will now be described by way of example in association with the accompanying drawings in which:

FIG. 1 is a basic schematic of the principal functioning integers or computer components which comprise the present invention;

FIG. 2 is a representation of a typical calendar grid showing a plurality of date cells and a plurality of value cells within each date cell;

FIG. 3 is a representation of a typical date cell, showing alternative manners of representation of data; and

FIG. 4 is an alternative representation of a typical calendar grid.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

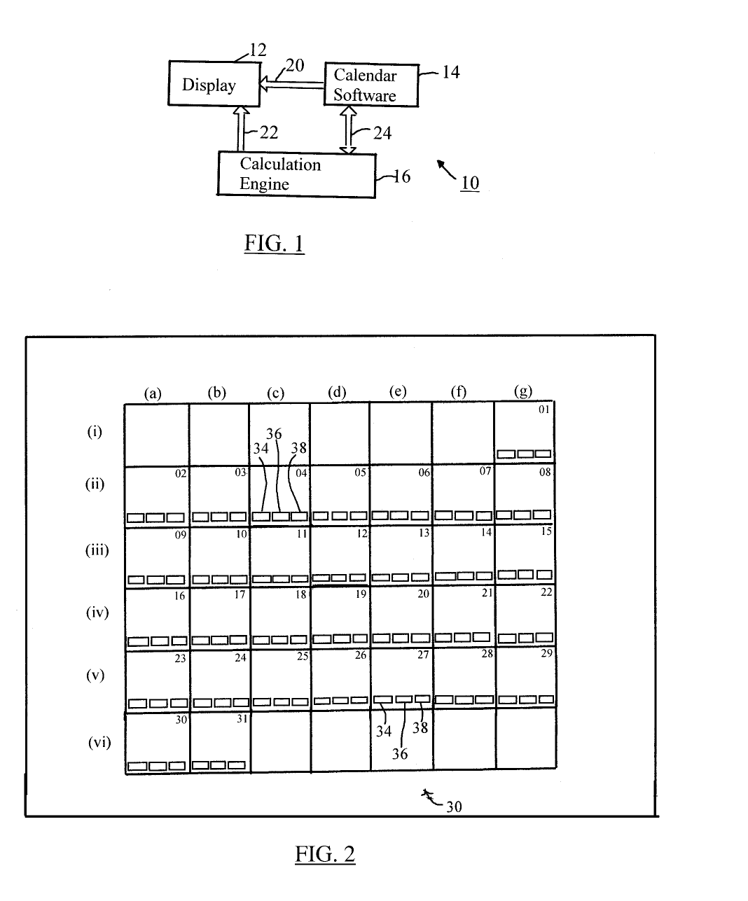

Turning first to FIG. 1, the general schematic for the computer operated, calendar-based financial calculator of the present invention is shown at 10. The three principal components are the computer display 12, the calendar software 14, and the calculation engine 16. The basic paths of data flow are shown by arrows 20, 22, and 24; it being noticed that data will be interchanged between the calendar software 14 and the calculation engine 16, and from the calendar software 14 and the calculation engine 16 to the computer display 12.

Reference is made to FIG. 2, where there is shown a calendar grid 30. A typical 31 day month is illustrated, having seven columns identified by the letters (a) to (g); and up to six rows identified by numerals (i) to (vi). It will be understood that any calendar grid 30 which may be displayed on the computer display 12 at any time will always have seven columns, one for each day of the week, and as few as four or as many as six rows. Each of the identified dates on the calendar grid therefore occupies its own date cell, and it will be understood that from the identity of the day, month, and year, each date cell will have a unique value. Moreover, that unique value for each date cell is such that it will be understood and can be acted upon by the calculation engine 16, in a manner such as that discussed hereafter.

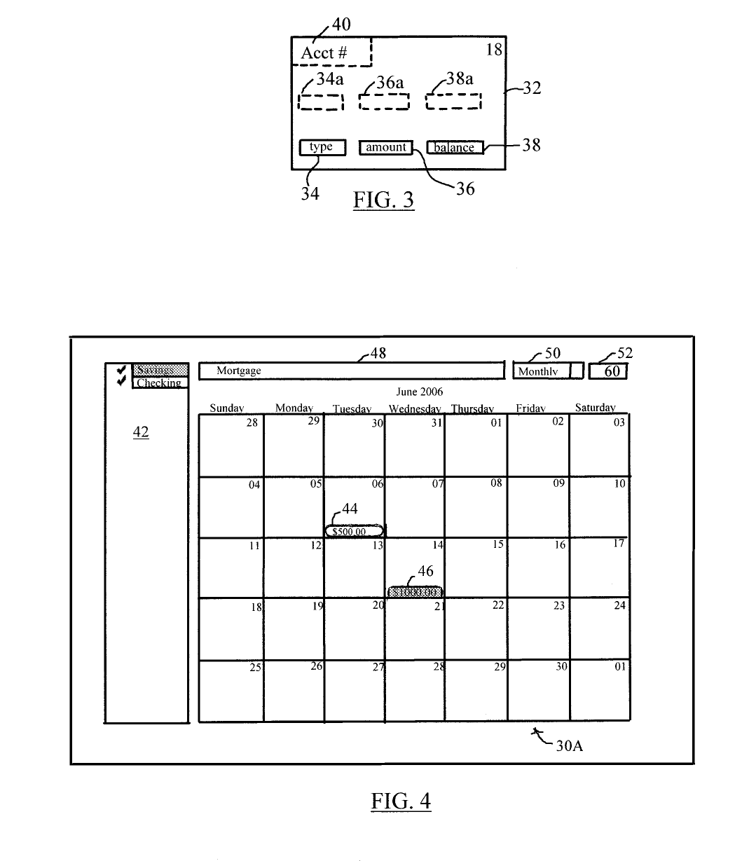

Also referring now to FIG. 3, a typical date cell 32 is shown. In this example, the chosen date cell 32 happens to be row (iv), column (c), and is for day 18 of the month currently being displayed. Within the date cell 32 there may be at least one, and most commonly more than one, value cells such as those identified at 34, 36, and 38. In the example shown, which assumes that data for a bank account is being displayed, the value which may be entered in value cell 34 may be such as to identify the nature of the transaction to be displayed. For example, that value might be a check number, a recurring payment such as a mortgage payment or car loan payment, a recurring deposit such as payroll or dividend earnings, and so on. In the example shown, the nature of that value is identified as being the “type” of transaction being displayed.

Although a date cell 32 may have but one value cell 34, as noted, it will typically have usually three value cells; also, as will be described hereafter, there may be more than three value cells. In any event, carrying on in the present example, the value that will appear in value cell 36 is typically the amount of the transaction identified by its type in value cell 34; and the running balance of the account will be identified in value cell 38.

It will be understood that when the calendar grid is first being set up, the identity of each of the value cells and the nature of the information that they will show will first be entered into each value cell in much the same manner as cells are identified in an ordinary spreadsheet program. Having established the nature of the information which will be shown in each of the cells, the computer program which is resident in the calculation engine, and which cooperates with the computer program which is resident in the calendar software, will be arranged so that a numerical value may be entered, for example, in value cell 36. However, it will be understood that the numerical value may be entered as raw data by the operator, or it may be entered automatically as a consequence of the computer program knowing the value of a recurring payment or deposit, as an example. Moreover, the data which will then appear in value cell 38 will, in general, be a calculated value which is arrived at by the calculation engine 16 which knows the prior account balance and will calculate a new account balance in accordance with the nature and amount of the transaction.

Moreover, the calculation engine 16 is capable of calculating a value for a similar value cell in another date cell in keeping with the numerical value which is entered into an operating value cell such as 36 of 38, which is presently being displayed on the computer display, for another value cell such as 36 or 38 in another date cell for a different date. Accordingly, recurring deposits or withdrawals can be programmed with discrete amounts, and a running balance will be maintained and displayed in any value cell 38 for any particular date.

It will be understood, of course, that the calculations to establish values which will appear in value cells will be in keeping with predetermined mathematical expressions which will initially be entered into each value cell as necessary. Entry of such mathematical expressions is in keeping with the ordinary rules surrounding entry of mathematical expressions in any spreadsheet program, and thus need not been discussed in detail here. In other words, the determination and entry of mathematical expressions into value cells, per se, are beyond the scope of the present invention; however, only the present invention accommodates such entry of mathematical expressions so as to display new values in related or identified value cells in other date cells.

It follows, of course, that any numerical value which is displayed in any value cell may be entered as a raw number, or it may be a calculated value that is written into that value cell as a consequence of the calculation which is made by the calculation engine 16 in keeping with the predetermined governing mathematical expression for that value cell.

It will thus be understood, as well, that the calculation engine 16 will maintain a list of all values and mathematical expressions that are entered or calculated for each value cell for each date which is relevant, as a function of the unique date values that are given to each date cell and in keeping with mathematical expressions relevant to the specific value cells. Thus, updated values for any given value cell will be sent to any selected or designated date cell in keeping with the respective predetermined governing mathematical expression for that the value cell and date cell.

It will also be understood, of course, to any person having knowledge of functioning computer operations and their setups, that the principal components of the general operating schematic may be located in a single, stand-alone computer, or they may be interconnected one to another by such as a LAN, a WAN, or the Internet.

Referring again to FIG. 3, it can be seen that data for differing financial categories or accounts may be displayed in any date cell by one of several different methods. For example, six value cells might be displayed, with an additional three value cells 34a, 36a, and 38a. The values and data entered and displayed in those additional value cells might be for a different financial category or account; for example, for a savings account as opposed to a checking account.

Another manner by which data for a different financial category or account may be displayed on the calendar grid 30 may be by choosing, for example, an account number or account type which might be displayed in box 40 in any date cell 32. After choosing the relevant account, the data that will be displayed in the value cells will be for that specific chosen account.

Alternatively, as shown in FIG. 4, various value cells can be colour-coded, or otherwise identified in a date cell. A listing 42 of accounts is provided to the left of calendar grid 30A. Value cells 44 and 46 are shown on dates 06 and 14 respectively, which show balances for the two accounts listed in list 42.

Is also understood, of course, that any value cell may be created for a date cell, and repeated as to the numerical value or mathematical expression therein for further date cells. In other words, once the value cell has been created, it may be easy replicated such as by copying that value cell into another date cell; or if the computer program will accommodate it, by being self-replicating into such other displayed date cells as may be necessary.

For example, in FIG. 4, there are three rectangles above calendar 30A. The first is input box 48 in which text, values or formulas can be entered. In box 48, text showing a mortgage payment is indicated. The second rectangle 50 represents a pull-down menu to select a repeat type, such as, for example, daily, weekly, bi-weekly, monthly, or the like. A monthly payment is shown in box 50. The third rectangle 52 is another input box for the number of times the cell repeats. In this case, the payment is made for 60 months.

Other arrangements and configurations will be apparent to the skilled artisan, however.

It will also be understood that when a mathematical expression is entered into a specific value cell and is to be repeated into further value cells having the same identity but for different date cells, then the mathematical expression may itself be modified in keeping with the requisite unique value for that respective date cell or cells where the mathematical expression is to be repeated. An example follows, below:

A mathematical expression which is written into a value cell for a specific date cell may reference the value of another value cell in a second date cell such as by an absolute reference which relies upon the unique value of the second date cell. Thus, an equation such as “=5* [Dec. 12, 2005]” will take the value which is contained in the specific value cell for the date cell of Dec. 12, 2005, multiply that value by 5, and display the result accordingly.

Still further, it is possible to make a relative reference from one date cell to another date cell whereby a temporal relationship to a unique date value which is based on the unique reference date value may be established. Having done that, then appropriate calculations may be made in keeping with the predetermined governing mathematical expression for the specific value cell based on the translated unique date values which are established by the calculation engine, which has the capability of translating those temporal relationships. For example, a number of days ahead or behind the date of a current date cell being displayed may be established in keeping with an ordinary English language reference such as “yesterday”, “tomorrow”, “last week”, “next week”, “last month”, “next month”, “last year”, “next year”, and so on. Any such reference will be interpreted by the calculation engine 16 and converted into a date.

Thus, an equation like “=1.07* [last month]” will find the date cell having the same day as the current day, but in the previous month, it will then find the necessary value in the appropriate value cell, and it will then add 7% to that value and display it in the date cell for the current day.

Moreover, such a cell and its value may then be copied or repeated for subsequent months, so as to arrive at a calculation for compounded interest, as an example.

Also, it will be clearly to the skilled artisan that the system of the present invention may be housed in different interconnected locations and devices. Preferably, however, the display, calendar calculating software, and calculation engine are all components of a single computer, or on a dedicated computer device.

Also, it is to be noted that the system of the present invention can be provided with the ability to serialize, or store, a representation of the calendar data to a permanent storage device such as a hard disk or flash memory device, for example, in such a way that the system can be shut down or turned off, and later turned on and the data can be reloaded into the system. Further, different data sets can be retrieved, modified, stored, transmitted or the like, in the same fashion as can any other forms of electronic data, such as spreadsheets, word processing documents, and the like.

There has been described a computer operated, calendar-based financial calculator which will display data for any given month on a computer display, where the data may be entered as raw data or displayed as calculated data as may be determined by a mathematical expression for any specific value cell in any given date cell. The determination of values in value cells may be in keeping with ordinary mathematical expressions and following typical calculations as may be found in an ordinary spreadsheet program. However, the determination of values is also dependent on the unique value for each date cell, which value can be understood and acted upon by the calculation engine.

Other modifications and alterations may be used in the design and setup of the present invention, without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A computer operated, calendar-based financial calculator comprising a computer display, calendar calculating software, and a calculation engine; wherein:
said calendar calculating software provides calendar data to said computer display so as to provide a visual presentation of any calendar month, and wherein each day of each month of each year has a unique numerical value which can be understood and acted upon by said calculation engine;
wherein at least one identified value cell is present in each date cell being displayed on said computer display, and wherein a numerical value or a mathematical expression may be entered into said at least one identified value cell; and
wherein said calculation engine is adapted to calculate a value for a similar identified value cell in any other date cell in keeping with the numerical value entered into an operating identified value cell presently being displayed on said computer display, and in keeping with a predetermined governing mathematical expression which has been previously entered for that operating identified value cell.

2. The computer operated, calendar-based financial calculator of claim 1, wherein said calculation engine maintains a list of all values and mathematical expressions for each value cell as a function of the unique date values for each date cell, so as to send updated values to any value cells for any selected date cells as determined by a respective predetermined governing mathematical expression therefor.

3. The computer operated, calendar-based financial calculator of claim 1, wherein a plurality of value cells are present in each date cell being displayed on said computer display;
wherein a value cell may be selected within a date cell, whereby a numerical value entered into a related value cell in said date cell will result in a calculation by said calculation engine for a numerical value to be displayed in a further related value cell in said date cell in keeping with said predetermined governing mathematical expression; and
wherein said calculated numerical value may result in further calculated numerical values for said further related value cells in other date cells, as may be determined by said predetermined governing mathematical expression.

4. The computer operated, calendar-based financial calculator of claim 1, wherein said computer display, said calendar calculating software, and said calculation engine, may be located in a single computer, or distributed among a plurality of computers linked together by LAN, WAN, or Internet.

5. The computer operated, calendar-based financial calculator of claim 1, wherein data for differing financial categories or accounts may be displayed in any date cell by preselection of a category or account indicator, or by selection of a group of related value cells in a date cell.

6. The computer operated, calendar-based financial calculator of claim 1, wherein a mathematical expression entered into a value cell may cause a determination by said calculation engine of a numerical value entered into another value cell by reference to the identity of that other value cell.

7. The computer operated, calendar-based financial calculator of claim 1, wherein the numerical value which is displayed in any value cell may be entered as a raw number, or may be a calculated value written into said value cell as a consequence of a calculation by said calculation engine in keeping with a predetermined governing mathematical expression for said value cell.

8. The computer operated, calendar-based financial calculator of claim 1, wherein any value cell may be created for a date cell, and repeated as to the numerical value or mathematical expression therein for further date cells.

9. The computer operated, calendar-based financial calculator of claim 8, wherein when a mathematical expression is in said value cell and is repeated in further value cells for different date cells, said mathematical expression may be modified in keeping with the requisite unique value for the respective date cell or cells where said mathematical expression is to be repeated.

10. The computer operated, calendar-based financial calculator of claim 8, wherein said calculation engine is capable of translating temporal relationships to unique date values, based on a unique reference date value, and to perform calculations in keeping with a predetermined governing mathematical expression based on said translated unique date values.

11. The computer operated, calendar-based financial calculator of claim 1, wherein said visual presentation of any calendar month comprises a calendar grid having seven columns and four to six rows of date cells.
